(19) United States
(12) Patent Application Publication
(10) Pub. No.: US 2013/0093797 A1
(43) Pub. Date: Apr. 18, 2013

(54) BACKLIGHT CONTROL UNIT AND DISPLAY DEVICE USING SAME AND BACKLIGHT CONTROL METHOD

(71) Applicant: XIN GUO, Shenzhen City (CN)

(72) Inventor: XIN GUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/340,590

(22) Filed: Dec. 29, 2011

(30) Foreign Application Priority Data
Oct. 17, 2011 (CN) 201110314554.5

(51) Int. Cl. G09G 5/10

(52) U.S. Cl. 345/690

(57) ABSTRACT

A backlight control unit for a display device includes a processing unit and a backlight control circuit. The display device includes a plurality of lamps and defines a plurality of display regions each display region being illuminated by at least one lamp. When the processing unit determines that one or more display regions on the display device are constantly displaying a black image, the processing unit outputs a control signal to the backlight control circuit. The backlight control circuit turns off the lamps serving the one or more display regions displaying the black image, based on the control signal.

### BACKGROUND

1. Technical Field

The present disclosure relates to a backlight control unit, a display device using the backlight control unit and a backlight control method thereof.

2. Description of Related Art

A liquid crystal display device generally includes a panel for displaying images, a backlight module for providing light to the panel, and a backlight control unit for controlling the backlight module. When the display device is displaying images, the lamps of the backlight module are all turned on by the backlight control unit. However, images may be only displayed on a portion of the display device, and the other portions of the display device may display a black image or no image. For example, when the display device is displaying a film, the display device displays dynamic images of the film on a central region of the display panel, and displays bars or a black image on a periphery of the display panel. Accordingly, power to the lamps below the bars or black image is wasted.

What is needed, therefore is a backlight control unit, a display device employing the backlight control unit, and a backlight control method that can overcome the aforementioned problems.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the various views.

FIG. 1 is a block diagram of one embodiment of a display device, the display device including a backlight module and a display panel.

FIG. 2 is a view of a plurality of regions of the display panel of FIG. 1 that are controlled by the backlight module.

FIG. 3 is a flowchart of a backlight control method of the display device of FIG. 1.

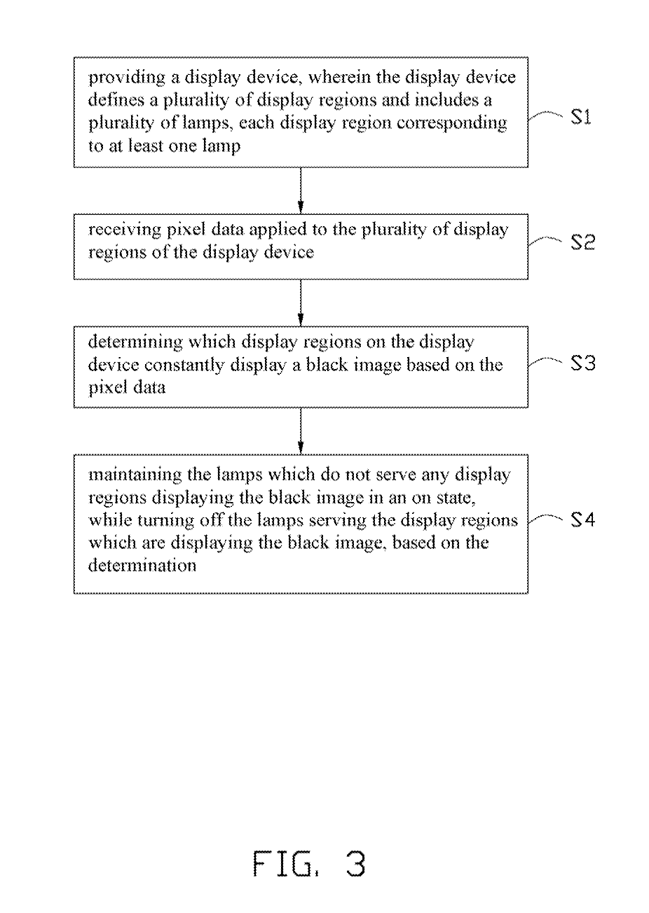

### DETAILED DESCRIPTION

Reference will be made to the drawings to describe specific exemplary embodiments of the present disclosure.

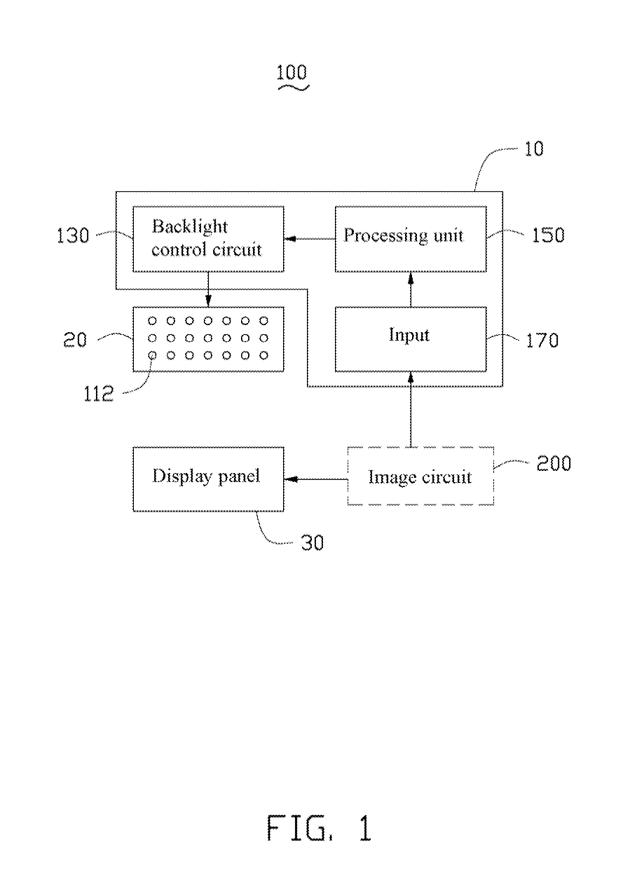

FIG. 1 is a block diagram of one embodiment of a display device 100. The display device 100 may be a liquid crystal display device, for example. The display device 100 includes a backlight control unit 10, a backlight module 20, and a display panel 30. The display panel 30 includes two opposite surfaces, a display surface and a back surface. The backlight module 20 is disposed adjacent and opposite to the back surface of the display panel 30, and provides light to the display panel 30 for displaying images. The backlight module 20 includes a plurality of lamps 112. The lamps 112 may be light emitting diodes, for example. The display panel 30 receives pixel data from an image circuit 200.

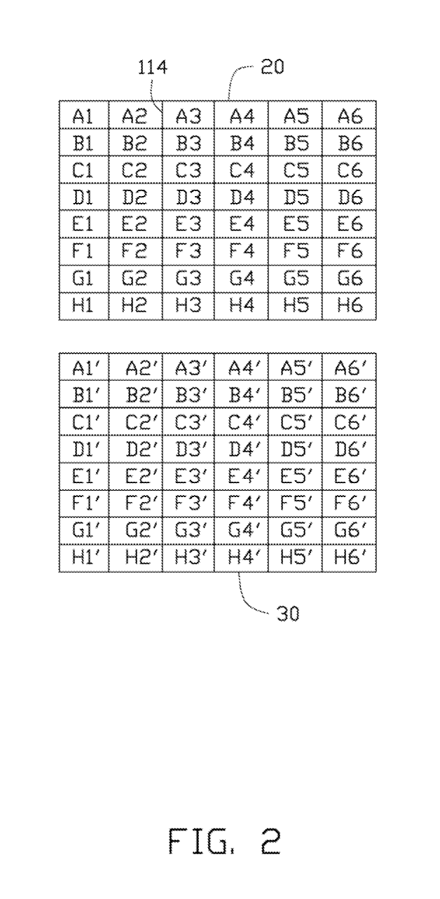

FIG. 2 is a view of a plurality of display regions A1′-A6′, B1′-B6′, C1′-C6′, D1′-D6′, E1′-E6′, F1′-F6′, G1′-G6′ and H1′-H6′ of the display panel 30 that are controlled by the backlight module 20. The plurality of display regions A1′-A6′, B1′-B6′, C1′-C6′, D1′-D6′, E1′-E6′, F1′-F6′, G1′-G6′ and H1′-H6′ may be the complete display surface of the display panel 30, or may be only one or more portions of the display panel 30, for example the periphery of the display panel 30. The backlight module 20 defines a plurality of backlight regions A1-A6, B1-B6, C1-C6, D1-D6, E1-E6, F1-F6, G1-G6 and H1-H6 corresponding to the display regions A1′-A6′, B1′-B6′, C1′-C6′, D1′-D6′, E1′-E6′, F1′-F6′, G1′-G6′ and H1′-H6′. Between any two backlight regions, a baffle 114 prevents light leaking from one backlight region to another adjacent region. The lamp(s) 112 serving a backlight region are dedicated to that region, and the lamps 112 for different backlight regions on the backlight module 20 may be turned on or off individually or together by the backlight control unit 10. The backlight control unit 10 receives pixel data applied to the display regions on the display panel 30, and determines which display regions, if any, on the display pane 30 are to display a black image for the current moment based on the pixel data. When one or more display regions of the display panel 30 are to display the black image for time being, the lamps 112 of the relevant backlight regions are turned off, and the lamps 112 of backlight regions which are not required to show a black image are allowed to remain switched on (maintained in an on state) by the backlight control unit 10. Thus, the lamps 112 serving display regions which are required to show moving or other images remain on. In an alternative embodiment, the baffle 114 may be omitted. Each backlight region may be served by one, or two, or more of the lamps 112.

The backlight control unit 10 includes a backlight control circuit 130, a processing unit 150 and an input 170. The backlight control circuit 130, the processing unit 150, and the input 170 are electronically connected in sequence. The input 170 receives the pixel data from the image circuit 200 and outputs the pixel data to the processing unit 150. The processing unit 150 determines which display regions must display a black image based on the pixel data, and outputs corresponding driving signals to the backlight control circuit 130. The backlight control circuit 130 controls the power supply to each of the lamps 112 in the backlight regions of the backlight module 20, based on the corresponding driving signals.

In detail, when the processing unit 150 determines that the pixel data applied to a certain display region of the display panel 30 are unchanging and are equivalent to a predetermined gray scale for producing a black image, the processing unit 150 outputs a first driving signal to the backlight control circuit 130. The backlight control circuit 130 outputs a first control signal to the backlight module 20. The lamps 112 serving the certain display region of the display panel 30 are turned off by the first control signal. In addition, when the processing unit 150 determines that the certain display region of the display panel 30 do not display the black image based on the pixel data, the processing unit outputs a second driving signal to the backlight control circuit 130. The backlight control circuit 130 outputs a second control signal to the backlight module 20. The lamps 112 serving the certain display region of the display panel 30 are turned on by the second control signal.

Referring to FIG. 2 again, when the whole display area of the display panel 30 is utilized to display a film (i.e., a movie), for example, if the film has a format of 16:9, and the display panel 30 has a size of 4:3, the display regions C1′-C6′, D1′-D6′, E1′-E6′ and F1′-F6′ display the images of the film file in the regular manner 16:9, and the other display regions A1′-A6′, B1′-B6′, G1′-G6′ and H1′-H6′ display an unchanging black image to create a “letter box” effect above and below the visible film. The backlight control unit 10 acquires the information that the display regions C1′-C6′, D1′-D6′, E1′-E6′ and F1′-F6′ are displaying moving or dynamic images, and display regions A1′-A6′, B1′-B6′, G1′-G6′ and H1′-H6′ are displaying the black image, based on the pixel data applied to the display regions A1′-A6′, B1′-B6′, C1′-C6′, D1′-D6′, E1′-E6′, F1′-F6′, G1′-G6′ and H1′-H6′, and outputs the first control signal to the backlight module 20. The lamps 112 serving the backlight regions A1-A6, B1-B6, G1-G6 and H1-H6 are turned off in compliance with the first control signal.

When the film is over, the display device 100 may start to display a web image instead and there is no black image required to be shown. The backlight control unit 10 outputs the second control signal to the backlight module 20. Accordingly, the lamps 112 serving the backlight regions A1-A6, B1-B6, G1-G6 and H1-H6 are turned on in compliance with the second control signal.

As described, since the backlight control unit 10 of the display device 100 turns off the lamps 112 serving the one or more display regions of the display panel 30 where the black image is intended to be shown based on the pixel data applied to the display panel 30, the saving in electrical power supplied to the lamps 112 is significant, and the power actually used is used far more efficiently.

FIG. 4 is a flowchart of a backlight control method of the display device 100 of FIG. 1. It is understood that additional steps may be added, others deleted, and the order of the steps may change depending on the embodiment. In step S1, providing a display device, wherein the display device defines a plurality of display regions and includes a plurality of lamps, each display region corresponding to at least one lamp. In step S2, receiving pixel data applied to the plurality of display regions of the display device. In step S3, determining which display regions on the display device constantly display a black image based on the pixel data. In step S4, maintaining the lamps which do not serve any display regions displaying the black image in an on state, while turning off the lamps serving the display regions which are displaying the black image, based on the determination.

It should be pointed out that in alternative embodiments, the image circuit 200 may be integrated in the display device 100. The number of the backlight and display regions of the backlight module 20 and the display pane 30 may be increased if the display device 100 is a larger display device, or be decreased if the display device 100 is a small display device.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A backlight control unit for a display device, the display device comprising a plurality of lamps and defining a plurality of display regions, each display region corresponding to at least one lamp, the backlight control unit comprising:
a processing unit configured to determine which display regions constantly display a black image, based on pixel data applied to the plurality of display regions; and
a backlight control circuit configured to control turn-on and turn-off of the plurality of lamps, based on a determination of the processing unit;
wherein the lamps which do not serve any display regions displaying the black image are maintained in an on state, while the lamps serving the display regions which are displaying the black image are turned off by the backlight control circuit, based on the determination.

2. The backlight control unit of claim 1, wherein when the processing unit determines that one or more display regions are displaying the black image, the processing unit outputs a first driving signal to the backlight control circuit, the backlight control circuit turns off the lamps serving the one or more display regions, based on the first driving signal.

3. The backlight control unit of claim 2, wherein when the processing unit determines that the one or more display regions do not display the black image, the processing unit outputs a second driving signal to the backlight control circuit, the backlight control circuit turns on the lamps serving the one or more display regions, based on the second driving signal.

4. The backlight control unit of claim 1, wherein when the processing unit acquires that the pixel data applied to a certain display region are unchanging and are equivalent to a predetermined gray scale for producing the black image, the processing unit determines that the certain display region are displaying the black image.

5. A display device, comprising:
a plurality of lamps;
a display panel defining a plurality of display regions, each display region on the display panel corresponding to at least one lamp; and
a backlight control unit, comprising:
a processing unit configured to determine which display regions on the display panel constantly display a black image, based on pixel data applied to the plurality of display regions; and
a backlight control circuit configured to control turn-on and turn-off of the plurality of lamps, based on a determination of the processing unit;
wherein the lamps which do not serve any display regions displaying the black image are maintained in an on state, while the lamps serving the display regions which are displaying the black image are turned off by the backlight control circuit, based on the determination.

6. The display device of claim 5, wherein when the processing unit determines that one or more display regions are displaying the black image, the processing unit outputs a first driving signal to the backlight control circuit, the backlight control circuit turns off the lamps serving the one or more display regions, based on the first driving signal.

7. The display device of claim 6, wherein when the processing unit determines that the one or more display regions do not display the black image, the processing unit outputs a second driving signal to the backlight control circuit, the backlight control circuit turns on the lamps serving the one or more display regions, based on the second driving signal.

8. The display device of claim 5, wherein when the processing unit acquires that the pixel data applied to a certain display region are unchanging and are equivalent to a predetermined gray scale for producing the black image, the processing unit determines that the certain display region are displaying the black image.

9. A backlight control method, comprising:
providing a display device, the display device defining a plurality of display regions and comprising a plurality of lamps, each display region corresponding to at least one lamp;
receiving pixel data applied to the plurality of display regions of the display device;
determining which display regions on the display device constantly display a black image based on the pixel data;
maintaining the lamps which do not serve any display regions displaying the black image in an on state, while turning off the lamps serving the display regions which are displaying the black image, based on the determination.

10. The backlight control method of claim 9, further comprising outputting a first driving signal when that one or more display regions constantly display the black image is determined, wherein the lamps serving the one or more display regions are turned off, based on the first driving signal.

11. The backlight control method of claim 10, further comprising outputting a second driving signal when that the one or more display regions do not display the black image is determined, wherein the lamps serving the one or more display regions are turned on, based on the second driving signal.

12. The backlight control method of claim 9, wherein when the pixel data applied to a certain display region are unchanging and are equivalent to a predetermined gray scale for producing the black image, the certain display region are displaying the black image is determined.
